(19) United States
(12) Patent Application Publication
(10) Pub. No.: US 2023/0356517 A1
(43) Pub. Date: Nov. 9, 2023

(54) PHA-BASED RETORT FOOD POUCH

(71) Applicant: Meredian, Inc., Bainbridge, GA (US)

(72) Inventors: Karson Durie, Athens, GA (US); Adam Johnson, Bainbridge, GA (US); Brock Merchant, Whigham, GA (US); Jerri DiRenzo, Wilmington, DE (US)

(73) Assignee: Meredian, Inc., Bainbridge, GA (US)

(21) Appl. No.: 18/143,797

(22) Filed: May 5, 2023

Related U.S. Application Data
(60) Provisional application No. 63/339,127, filed on May 6, 2022.

(51) Int. Cl. B32B 27/36; B32B 7/12; B32B 27/34; B32B 15/088; B32B 15/09; B32B 15/20

(52) U.S. Cl. CPC B32B 27/36; B32B 7/12; B32B 27/34; B32B 15/088; B32B 15/09; B32B 15/20; B32B 2439/70; B32B 2307/31; B32B 2307/7163; B32B 2307/7265; B32B 2307/75; B32B 2307/4023; B32B 2307/7376; B32B 2307/518; B32B 2307/7244; B32B 2307/7246; B32B 2307/306

(57) ABSTRACT

A retort food pouch is disclosed, including at least one sidewall and a pouch closure. The sidewall is a multi-layer structure which is made up of: (1) a biodegradable heat-sealable layer which includes polyhydroxyalkanoates; (2) a barrier layer which includes aluminum and/or polyhydroxyalkanoates; (3) optionally, a nylon layer; and (4) a biodegradable printed layer which also includes polyhydroxyalkanoates and/or cellulose. These layers are adhered together with one or more adhesives to form the multi-layer structure.

### FIELD

This disclosure relates to biodegradable polymeric compositions. More particularly, this disclosure relates to a retort food pouch formed from a multi-layer structure that includes layers that are biodegradable and/or home compostable.

### BACKGROUND

In food packaging, retorting is a method in which food is cooked and preserved at higher temperatures and then vacuum sealed in a pouch-like food package to be eaten later. This process extends the shelf-life of the food products and allows the food products to be sold “ready-to-eat,” where the food can be eaten as is or reheated. Retorting is preferred over canning, as it results in lighter packaging for transport and less energy in preparation. Common foods prepared via retorting include meats, soups, rice, and curries, and the most common example of retort packaging is the MRE (Meal Ready to Eat), which is most commonly used in the military.

Retort packages must be able to be heat-sealed and heated to high temperatures (˜120° C.) while providing barrier properties against water and oxygen. For commercial applications, they also must be printable for marketing purposes. These performance requirements are met by using multiple layers of materials, with each providing a specific purpose. Conventionally, these materials include polypropylene, nylon, polyethylene terephthalate, polyethylene, and aluminum. The plastics utilized, however, are petroleum-based and are not sustainable options. Additionally, recycling these packages proves difficult as the different materials will be hard to separate and may contaminate individual recycling streams if recycled together.

It would be desirable to provide a multi-layer food packaging structure suitable for preparing food retort packages in which at least some of the individual layers of the multi-layer structure are biodegradable and/or compostable. Preferably, the entire food retort package would be biodegradable and/or compostable.

### SUMMARY OF THE INVENTION

The above and other needs are met by a retort food pouch provided according to the present disclosure. According to one embodiment, the retort food pouch includes at least one sidewall and a pouch closure. This at least one sidewall is a multi-layer structure which is made up of: (1) a biodegradable heat-sealable layer which includes polyhydroxyalkanoates; (2) a barrier layer which includes aluminum and/or polyhydroxyalkanoates; (3) optionally, a nylon layer; and (4) a biodegradable printed layer which also includes polyhydroxyalkanoates and/or cellulose. These layers are adhered together with one or more adhesives to form the multi-layer structure.

In certain embodiments, the biodegradable heat-sealable layer preferably includes: (1) from about 10 to about 99 weight percent polyhydroxyalkanoates; (2) from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof; (3) from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and (4) optionally, from about 1 to about 25 weight percent of at least one filler selected from the group consisting of clays, calcium carbonate, talc, kaolinite, montomorillonite, bentonite, silica, chitin, titanium dioxide, nano clay, and mixtures thereof.

In some embodiments, the polyhydroxyalkanoate in the biodegradable heat-sealable layer more preferably includes poly-3-hydroxybutyrate-co-3-hydroxyhexanaote (P3HB-co-P3HHx).

In some instances, the biodegradable heat-sealable layer more preferably includes from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

According to some embodiments, the biodegradable heat-sealable layer more preferably includes a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyvalerate, 3-hydroxyoctanoate, 3-hydroxydecanoate, and mixtures thereof.

In certain embodiments, the biodegradable heat-sealable layer preferably includes polyhydroxyalkanoates having a weight average molecular weight from about 50 thousand Daltons to about 2.5 million Daltons as determined by ASTM D5296-05

According to certain embodiments, the barrier layer preferably includes: (1) from about 10 to about 99 weight percent polyhydroxyalkanoates; (2) from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof; (3) from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and (4) optionally, from about 1 to about 25 weight percent of at least one filler selected from the group consisting of clays, calcium carbonate, talc, kaolinite, montomorillonite, bentonite, silica, chitin, titanium dioxide, nano clay, and mixtures thereof.

In some instances, the polyhydroxyalkanoate in the barrier layer is preferably made up of poly-3-hydroxybutyrate-co-3-hydroxyhexanaote (P3HB-co-P3HHx).

In some embodiments, the barrier layer preferably includes from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

In other embodiments, the barrier layer preferably includes a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyvalerate, 3-hydroxyoctanoate, 3-hydroxydecanoate, and mixtures thereof.

According to certain embodiments, the barrier layer preferably includes polyhydroxyalkanoates having a weight average molecular weight from about 50 thousand Daltons to about 2.5 million Daltons as determined by ASTM D5296-05.

In some instances, the barrier layer preferably includes aluminum.

In some embodiments, the multi-layer structure preferably has an overall thickness of from about 25 to about 75 microns. The aluminum barrier layer preferably has a thickness of from about 3 to about 13 microns. When the optional biaxially oriented nylon layer is present, this nylon layer preferably has a thickness from about 5 to about 15 microns.

According to some embodiments, the biodegradable printed layer preferably includes: (1) from about 10 to about 99 weight percent polyhydroxyalkanoates; (2) from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof; (3) from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and (4) optionally, from about 1 to about 25 weight percent of at least one filler selected from the group consisting of clays, calcium carbonate, talc, kaolinite, montomorillonite, bentonite, silica, chitin, titanium dioxide, nano clay, and mixtures thereof.

According to certain embodiments, the biodegradable, printed layer is preferably made up of a core sub-layer and at least one skin sub-layer.

In some instances, the polyhydroxyalkanoate in the biodegradable printed layer more preferably includes poly-3-hydroxybutyrate-co-3-hydroxyhexanaote (P3HB-co-P3HHx).

In some instances, the biodegradable printed layer more preferably includes from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

According to certain embodiments, the biodegradable printed layer more preferably includes a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyvalerate, 3-hydroxyoctanoate, 3-hydroxydecanoate, and mixtures thereof.

In some embodiments, the biodegradable printed layer preferably includes polyhydroxyalkanoates having a weight average molecular weight from about 50 thousand Daltons to about 2.5 million Daltons as determined by ASTM D5296-05

Alternatively, according to some embodiments, the printed layer may be made of a biodegradable cellulose-based material.

In some instances, the biodegradable printed layer preferably has a thickness from about 5 to about 25 microns.

According to certain embodiments, the biodegradable printed layer is preferably printed using a flexographic, gravure, or digital printing method.

In some embodiments, the layers of the multi-layer structure are preferably adhered together with at least one adhesive, which comprises at least one polymer selected from the group consisting of polycaprolactone, isocyanates, polyurethanes, polybutylene succinate-co-adipate, polybutylene adipate-co-terephthalate, polyhydroxyalkanoates, polylactic acid, and mixtures thereof.

In certain embodiments, wherein all the layers of the multi-layer structure preferably have a melting point greater than 120° C. as determined by ASTM E794-06.

In some embodiments, the retort food pouch has a shelf-life of at least 18 months, as determined by ASTM E2454.

According to certain preferred embodiments, the multi-layer structure has an oxygen transmission rate of less than 0.45 ml/m²/24 h, as determined according to ASTM D3985. Moreover, the multi-layer structure also preferably has a water vapor transmission rate of less than 0.2 g/m²/24 h, according to ASTM F1249.

### DETAILED DESCRIPTION

As used herein, the term “biodegradable” refers to a plastic or polymeric material that will undergo biodegradation by living organisms (microbes) in anaerobic or aerobic environments, as determined by ASTM D5511 (anaerobic) and D5338 (aerobic).

As used herein, the term “compostable” refers to a plastic or polymeric material which will undergo biodegradation in a home composting environment, as determined by ASTM D6868.

In a first aspect, the present disclosure provides a retort food pouch. The retort food pouch includes a least one sidewall and a pouch closure. A roll of the multi-layer film structure is first formed into a series of retort food pouches. Each pouch is formed by folding and heat sealing a length of the multi-layer film structure along the bottom and the sides of the pouch. A general pouch shape is thus formed, having an open top.

The top of the pouch is then opened, and the pouch is filled with food. In some instances, food solids and food liquids may be added to the retort pouch at separate food filling stations. The interior of the retort pouch may also be flushed with nitrogen gas to provide an oxygen-reduced environment within the pouch and thereby improve food storage longevity.

The top of the filled pouch is then heat-sealed, and the filled and sealed pouch may be heated to cook and sterilize the pouch and its food contents.

The sidewall of the retort pouch is, in turn, provided from a multi-layer film structure. This multi-layer structure typically includes at least (1) a biodegradable heat-sealable layer which includes polyhydroxyalkanoates; (2) a barrier layer comprising aluminum and/or polyhydroxyalkanoates; and (3) a biodegradable printed layer which also includes polyhydroxyalkanoates and/or cellulose. In some instances, the multi-layer structure may also include a nylon film layer. Thus, in such embodiments, the multi-layer structure is made up of: (1) a biodegradable heat-sealable layer which includes polyhydroxyalkanoates; (2) a barrier layer comprising aluminum and/or polyhydroxyalkanoates; (3) a nylon layer; and (4) a biodegradable printed layer which also includes polyhydroxyalkanoates and/or cellulose.

In general, the multi-layer structure preferably has an overall thickness of from about 25 to about 75 microns.

As noted above, the first layer of the multi-layer structure is a biodegradable heat-sealable layer which comprises at least one form of polyhydroxyalkanoates. In some instances, the polyhydroxyalkanoates of this heat-sealable layer may be a homopolymer. More typically, however, the polyhydroxyalkanoates of this heat-sealable layer comprise a polyhydroxyalkanoate copolymer or terpolymer.

For instance, in certain embodiments, the biodegradable heat-sealable layer may comprise a polyhydroxyalkanoate copolymer, such as poly-3-hydroxybutyrate-co-3-hydroxyhexanaote (P3HB-co-P3HHx).

More generally, the biodegradable heat-sealable layer may comprise from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

In other embodiments, the biodegradable heat-sealable layer may comprise a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyvalerate, 3-hydroxyoctanoate, 3-hydroxydecanoate, and mixtures thereof.

In general, the polyhydroxyalkanoates in the biodegradable heat-sealable layer may have a weight average molecular weight from about 50 thousand Daltons to about 2.5 million Daltons as determined by ASTM D5296-05.

In general, the amount of the polyhydroxyalkanoates in the biodegradable heat-sealable is preferably from about 10 to about 99 weight percent of the heat-sealable layer.

In some instances, the heat-sealable layer may also comprise about 1 to 90 weight percent of at least one additional biodegradable polymer. This additional biodegradable polymer is preferably selected from the group consisting of polybutylene succinate, polycaprolactone, polybutylene succinate-co-butylene adipate, polybutylene adipate-co-terephthalate, polylactic acid, cellulose acetate, and mixtures thereof.

The heat-sealable layer also generally comprises a nucleating agent. Preferably, the heat-sealable layer comprises from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof.

In some instances, the heat-sealable layer may also include from about 1 to about 25 weight percent of at least one filler selected from the group consisting of clays, calcium carbonate, talc, kaolinite, montmorillonite, bentonite, silica, chitin, titanium dioxide, nano clay, and mixtures thereof. A particularly preferred filler is talc.

The multi-layer structure also includes a barrier layer which acts to limit the transmission of atmospheric oxygen and/or moisture through the multi-layer structure. This barrier layer comprises aluminum and/or polyhydroxyalkanoates.

For instance, the barrier may comprise an aluminum layer alone. In such embodiments, this aluminum barrier layer preferably has a thickness of from about 3 to about 13 microns. In other embodiments, the barrier layer may be provided by a layer comprising polyhydroxyalkanoates. In still other embodiments, the barrier layer may be comprised of a sublayer of aluminum and a sublayer of polyhydroxyalkanoates.

When polyhydroxyalkanoates are present in the barrier layer, the polyhydroxyalkanoates may comprise a homopolymer, a copolymer, or a terpolymer.

Thus, the barrier layer comprises a polyhydroxyalkanoate copolymer, such as poly-3-hydroxybutyrate-co-3-hydroxyhexanaote (P3HB-co-P3HHx). In general, the barrier layer may comprise from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

In other embodiments, the barrier layer may comprise a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyvalerate, 3-hydroxyoctanoate, 3-hydroxydecanoate, and mixtures thereof.

In certain embodiments, the heat-sealable layer may also comprise about 1 to 90 weight percent of at least one additional biodegradable polymer. This additional biodegradable polymer is preferably selected from the group consisting of polybutylene succinate, polycaprolactone, polybutylene succinate-co-butylene adipate, polybutylene adipate-co-terephthalate, polylactic acid, cellulose acetate, and mixtures thereof.

The barrier layer also preferably comprises a nucleating agent. Preferably, the heat-sealable layer comprises from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof.

In some instances, the barrier layer may also comprise from about 1 to about 25 weight percent of at least one filler selected from the group consisting of clays, calcium carbonate, talc, kaolinite, montmorillonite, bentonite, silica, chitin, titanium dioxide, nano clay, and mixtures thereof. A particularly preferred filler is talc.

In some embodiments, the multi-layer structure may also include a layer of nylon film in addition to the heat-sealable layer, the aluminum barrier layer, and the printed layer. When present, the additional nylon layer imparts extra strength, durability, and puncture resistance to the multi-layer structure.

When present, the nylon film layer is typically stretch-oriented and is preferably biaxially oriented. The nylon layer also preferably has a thickness from about 5 to about 15 microns.

The multi-layer structure also includes a biodegradable printed layer which comprises at least one form of polyhydroxyalkanoates and/or cellulose. This biodegradable printed layer is preferably printed with product packaging information using a flexographic, gravure, or digital printing method.

Similar to the heat-sealable layer discussed above, this printed layer may comprise polyhydroxyalkanoates in the form of a homopolymer, a copolymer, or a terpolymer. Alternatively, according to some embodiments, the printed layer may be made of a biodegradable cellulose-based material.

For instance, the biodegradable printed layer may comprise a polyhydroxyalkanoate copolymer such as poly-3-hydroxybutyrate-co-3-hydroxyhexanaote (P3HB-co-P3HHx).

More generally, the biodegradable printed layer may comprise from about 1.0 to about 15.0 weight percent of at least one polyhydroxyalkanoate comprising from about 25 to about 50 mole percent monomer residues of a 3-hydoxyalkanoate selected from the group consisting of 3-hydroxyvalerate, 3-hydroxyhexanoate, 3-hydroxyoctanoate, 3-hydroxydecanoate, and mixtures thereof.

In other embodiments, the biodegradable printed layer may comprise a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyvalerate, 3-hydroxyoctanoate, 3-hydroxydecanoate, and mixtures thereof.

Typically, the polyhydroxyalkanoates in the biodegradable printed layer have a weight average molecular weight from about 50 thousand Daltons to about 2.5 million Daltons as determined by ASTM D5296-05.

In general, the amount of the polyhydroxyalkanoates in the biodegradable printed is preferably from about 10 to about 99 weight percent of the heat-sealable layer.

According to certain embodiments, the printed layer may also comprise about 1 to 90 weight percent of at least one additional biodegradable polymer. This additional biodegradable polymer is preferably selected from the group consisting of polybutylene succinate, polycaprolactone, polybutylene succinate-co-butylene adipate, polybutylene adipate-co-terephthalate, polylactic acid, cellulose acetate, and mixtures thereof. Moreover, the printed layer also generally comprises a nucleating agent. Preferably, the heat-sealable layer comprises from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof.

Preferably, the biodegradable printed layer has a thickness from about 5 to about 25 microns.

Each of the aforementioned individual layers is adhered together with one or more adhesives to form the multi-layer structure. Preferably, the adhesive comprises a biodegradable material (as determined by ASTM D5338 and/or compostable (as determined by ASTM D6400). For example, in some embodiments, the layers of the multi-layer structure may be adhered together with at least one adhesive, which comprises at least one polymer selected from the group consisting of polycaprolactone, isocyanates, polyurethanes, polybutylene succinate-co-adipate, polybutylene adipate-co-terephthalate, polyhydroxyalkanoates, polylactic acid, and mixtures thereof.

The multi-layer structure prepared according to the present disclosure provides good barrier properties for the storage and preservation of the food product, which is enclosed within the retort pouch.

In particular, in certain embodiments, the multi-layer structure preferably has an oxygen transmission rate of less than 0.45 ml/m²/24 h, as determined according to ASTM D3985. For comparison, a polyethylene terephthalate (PET) film might typically have an oxygen transmission rate from about 15 to about 90 ml/m²/24 h under the same testing conditions. A polyethylene (PE) film might typically have an oxygen transmission rate from about 1550 to about 2500 ml/m²/24 h under the same testing conditions.

Moreover, the multi-layer structure also preferably has a water vapor transmission rate of less than 0.2 g/m²/24 h, according to ASTM F1249. For comparison, a polyethylene terephthalate (PET) film might typically have a water vapor transmission rate from about 1.5 ml/m²/24 h to about 80 ml/m²/24 h under the same testing conditions. A polyethylene (PE) film might typically have a water vision transmission rate from about 1.5 ml/m²/24 h to about 15.5 ml/m²/24 h under the same testing conditions.

The retort food pouch also preferably has a shelf-life of at least 18 months, as determined by ASTM E2454.

Moreover, all the layers of the multi-layer structure preferably have a melting point greater than 120° C., as determined by ASTM E794-06. More preferably all the layers of the multi-layer structure preferably have a melting point greater than 150° C. as determined by ASTM E794-06. Since retort-packaged foods are commonly cooked/sterilized within the retort pouch at a temperature of about 136° C., the higher melting points of the materials used to form the pouch ensure the integrity of the pouch will be maintained during the food cooking process.

At the same time, at least the heat-sealable layer and the printed layer of the multi-layer sidewall structure are biodegradable. Preferably, least the heat-sealable layer and the printed layer of the multi-layer sidewall structure are also home-compostable. If the optional nylon layer is omitted, all the polymer-based layers of the multi-layer sidewall structure are preferably biodegradable and/or home-compostable.

The present disclosure is also further illustrated by the following embodiments:

Embodiment 1. A retort food pouch having at least one sidewall and a pouch closure, wherein the at least sidewall is a multi-layer structure comprising:
a biodegradable heat-sealable layer comprising polyhydroxyalkanoates;
a barrier layer comprising aluminum and/or polyhydroxyalkanoates;
optionally, a nylon layer; and
a biodegradable printed layer comprising polyhydroxyalkanoates and/or cellulose,
wherein the layers are adhered together with one or more adhesives to form the multi-layer structure.

Embodiment 2. The retort food pouch of embodiment 1, wherein the biodegradable heat sealable layer comprises:
from about 10 to about 99 weight percent polyhydroxyalkanoates;
from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof;
from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and
optionally, from about 1 to about 25 weight percent of at least one filler selected from the group consisting of clays, calcium carbonate, talc, kaolinite, montmorillonite, bentonite, silica, chitin, titanium dioxide, nano clay, and mixtures thereof.

Embodiment 3. The retort food pouch of embodiments 1 or 2, wherein the polyhydroxyalkanoate in the biodegradable heat sealable layer comprises poly-3-hydroxybutyrate-co-3-hydroxyhexanaote (P3HB-co-P3HHx).

Embodiment 4. The retort food pouch, according to any of the preceding embodiments, wherein the biodegradable heat sealable layer comprises from about 1.0 to about 15.0 weight percent of at least one polyhydroxyalkanoate comprising from about 25 to about 50 mole percent monomer residues of a 3-hydoxyalkanoate selected from the group consisting of 3-hydroxyvalerate, 3-hydroxyhexanoate, 3-hydroxyoctanoate, 3-hydroxydecanoate, and mixtures thereof.

Embodiment 5. The retort food pouch, according to any of the preceding embodiments, wherein the biodegradable heat sealable layer comprises a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyvalerate, 3-hydroxyoctanoate, 3-hydroxydecanoate, and mixtures thereof.

Embodiment 6. The retort food pouch, according to any of the preceding embodiments, wherein the biodegradable heat sealable layer comprises polyhydroxyalkanoates having a weight average molecular weight from about 50 thousand Daltons to about 2.5 million Daltons as determined by ASTM D5296-05.

Embodiment 7. The retort food pouch, according to any of the preceding embodiments, wherein the barrier layer comprises:
from about 10 to about 99 weight percent polyhydroxyalkanoates;
from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof;
from about 0.1 weight percent to about 25 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and
optionally, from about 1 to about 25 weight percent of at least one filler selected from the group consisting of clays, calcium carbonate, talc, kaolinite, montmorillonite, bentonite, silica, chitin, titanium dioxide, nano clay, and mixtures thereof.

Embodiment 8. The retort food pouch, according to embodiment 7, wherein the polyhydroxyalkanoate in the barrier layer comprises poly-3-hydroxybutyrate-co-3-hydroxyhexanaote (P3HB-co-P3HHx).

Embodiment 9. The retort food pouch, according to embodiment 7 or 8, wherein the barrier layer comprises from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

Embodiment 10. The retort food pouch, according to any of embodiments 7-9, wherein the barrier layer comprises a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyvalerate, 3-hydroxyoctanoate, 3-hydroxydecanoate, and mixtures thereof.

Embodiment 11. The retort food pouch, according to any of embodiments 7-10, wherein the barrier layer comprises polyhydroxyalkanoates having a weight average molecular weight from about 50 thousand Daltons to about 2.5 million Daltons as determined by ASTM D5296-05.

Embodiment 12. The retort food pouch, according to embodiment 7, wherein the barrier layer comprises aluminum.

Embodiment 13. The retort food pouch, according to any of the preceding embodiments, wherein the multi-layer structure has an overall thickness of from about 25 to about 75 microns.

Embodiment 14. The retort food pouch, according to any of the preceding Embodiments, wherein the aluminum barrier layer has a thickness of from about 3 to about 13 microns.

Embodiment 15. The retort food pouch, according to any of the preceding embodiments, wherein the multi-layer structure comprises a biaxially oriented nylon layer, having a thickness from about 5 to about 15 microns.

Embodiment 16. The retort food pouch according to any of the preceding embodiments, wherein the biodegradable printed layer comprises:
from about 10 to about 99 weight percent polyhydroxyalkanoates;
from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof; and
from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof.

Embodiment 17. The retort food pouch, according to embodiment 16, wherein the polyhydroxyalkanoate in the biodegradable printed layer comprises poly-3-hydroxybutyrate-co-3-hydroxyhexanaote (P3HB-co-P3HHx).

Embodiment 18. The retort food pouch, according to embodiments 16 or 17, wherein the biodegradable printed layer comprises from about 1.0 to about 15.0 weight percent of at least one polyhydroxyalkanoate comprising from about 25 to about 50 mole percent monomer residues of a 3-hydoxyalkanoate selected from the group consisting of 3-hydroxyvalerate, 3-hydroxyhexanoate, 3-hydroxyoctanoate, 3-hydroxydecanoate, and mixtures thereof.

Embodiment 19. The retort food pouch, according to any of embodiments 16-18, wherein the biodegradable printed layer comprises a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyvalerate, 3-hydroxyoctanoate, 3-hydroxydecanoate, and mixtures thereof.

Embodiment 20. The retort food pouch, according to any of embodiments 16-19, wherein the biodegradable printed layer comprises polyhydroxyalkanoates having a weight average molecular weight from about 50 thousand Daltons to about 2.5 million Daltons as determined by ASTM D 5296-05.

Embodiment 21. The retort food pouch, according to any of embodiments 16-20, wherein the biodegradable printed layer has a thickness from about 5 to about 25 microns.

Embodiment 22. The retort food pouch, according to any of the preceding embodiments, wherein the biodegradable printed layer is printed using a flexographic, gravure, or digital printing method.

Embodiment 23. The retort food pouch, according to any of the preceding embodiments, wherein the layers are adhered together with at least one adhesive which comprises at least one polymer selected from the group consisting of polycaprolactone, isocyanates, polyurethanes, polybutylene succinate-co-adipate, polybutylene adipate-co-terephthalate, polyhydroxyalkanoates, polylactic acid, and mixtures thereof.

Embodiment 24. The retort food pouch, according to any of the preceding embodiments, wherein all the layers of the multi-layer structure have a melting point greater than 120° C. as determined by ASTM E794-06.

Embodiment 25. The retort food pouch, according to any of the preceding embodiments, wherein the retort food pouch has a shelf-life of at least 18 months, as determined by ASTM E2454.

Embodiment 26. The retort food pouch, according to any of the preceding embodiments, wherein the multi-layer structure has an oxygen transmission rate of less than 0.45 ml/m²/24 h, as determined according to ASTM D3985.

Embodiment 27. The retort food pouch, according to any of the preceding embodiments, wherein the multi-layer structure has a water vapor transmission rate of less than 0.2 g/m²/24 h, according to ASTM F1249.

### EXAMPLES

The following non-limiting examples illustrate various additional aspects of the invention. Unless otherwise indicated, temperatures are in degrees Celsius, and percentages are by weight based on the dry weight of the formulation.

### Example 1

In this example, a series of formulations suitable for biodegradable films were compounded in an Entek twin screw extruder. The make-up of the formulations, weight percent, is shown in Table 1 below:

TABLE 1

| | Formula- | Formula- | Formula- | Formula- |
|---|---|---|---|---|
| Component | tion 1 | tion 2 | tion 3 | tion 4 |
| PHB-co-PHxx | 46% | 51% | 46% | 51% |
| PHB | 5% | — | 5% | — |
| PBS | 23% | 23% | — | — |
| PBAT | — | — | 23% | 23% |
| Behenamide | 2% | 2% | 2% | 2% |
| Talc | 22% | 22% | 22% | 22% |
| Clay | 2% | 2% | 2% | 2% |

### Example 1

In this example, the resin formulations from Example 1 above were converted into blown film (1.25 mil) and tested for heat resistance under the following conditions: traditional convection oven (120° C., 5 min), boiling water (100° C./30 min), and microwave oven (1000W, 90 s). The films were evaluated for percent shrinkage in both machine and transverse directions. The results are shown in Table 2.

| Method | Direction | 1 | 2 | 3 | 4 |
|---|---|---|---|---|---|
| Oven | MD (%) | 0 | 0 | 0 | 0 |
| | TD (%) | 0 | 0 | 0 | 0 |
| Boiling Water | MD (%) | 1 | 0 | 0 | 1 |
| | TD (%) | 1 | 0 | 0 | 1 |
| Microwave | MD (%) | 0 | 0 | 0 | 0 |
| | TD (%) | 0 | 0 | 0 | 0 |

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A retort food pouch having at least one sidewall and a pouch closure, wherein the at least sidewall is a multi-layer structure comprising:
a biodegradable heat-sealable layer comprising polyhydroxyalkanoates;
a barrier layer comprising aluminum and/or polyhydroxyalkanoates;
optionally, a nylon layer; and
a biodegradable printed layer comprising polyhydroxyalkanoates,
wherein the layers are adhered together with one or more adhesives to form the multi-layer structure.

2. The retort food pouch of claim 1, wherein the biodegradable heat sealable layer comprises:
from about 10 to about 99 weight percent polyhydroxyalkanoates;
from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof;
from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and
optionally, from about 1 to about 25 weight percent of at least one filler selected from the group consisting of clays, calcium carbonate, talc, kaolinite, montmorillonite, bentonite, silica, chitin, titanium dioxide, nano clay, and mixtures thereof.

3. The retort food pouch of claim 2, wherein the polyhydroxyalkanoate in the biodegradable heat sealable layer comprises poly-3-hydroxybutyrate-co-3-hydroxyhexanaote (P3HB-co-P3HHx).

4. The retort food pouch of claim 2, wherein the biodegradable heat sealable layer comprises from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

5. The retort food pouch of claim 2, wherein the biodegradable heat sealable layer comprises a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyvalerate, 3-hydroxyoctanoate, 3-hydroxydecanoate, and mixtures thereof.

6. The retort food pouch of claim 2, wherein the biodegradable heat sealable layer comprises polyhydroxyalkanoates having a weight average molecular weight from about 50 thousand Daltons to about 2.5 million Daltons as determined by ASTM D5296-05.

7. The retort food pouch of claim 1, wherein the barrier layer comprises:
from about 10 to about 99 weight percent polyhydroxyalkanoates;
from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof;
from about 0.1 weight percent to about 25 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and
optionally, from about 1 to about 25 weight percent of at least one filler selected from the group consisting of clays, calcium carbonate, talc, kaolinite, montmorillonite, bentonite, silica, chitin, titanium dioxide, nano clay, and mixtures thereof.

8. The retort food pouch of claim 7, wherein the polyhydroxyalkanoate in the barrier layer comprises poly-3-hydroxybutyrate-co-3-hydroxyhexanaote (P3HB-co-P3HHx).

9. The retort food pouch of claim 7, wherein the barrier layer comprises from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

10. The retort food pouch of claim 7, wherein the barrier layer comprises a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyoctanoate, 3-hydroxydecanoate, and mixtures thereof.

11. The retort food pouch of claim 7, wherein the barrier layer comprises polyhydroxyalkanoates having a weight average molecular weight from about 50 thousand Daltons to about 2.5 million Daltons as determined by ASTM D5296-05.

12. The retort food pouch of claim 1, wherein the barrier layer comprises aluminum.

13. The retort food pouch of claim 1, wherein the multi-layer structure has an overall thickness of from about 25 to about 75 microns.

14. The retort food pouch of claim 1, wherein the aluminum barrier layer has a thickness of from about 3 to about 13 microns.

15. The retort food pouch of claim 1, wherein the multi-layer structure comprises a biaxially oriented nylon layer, having a thickness from about 5 to about 15 microns.

16. The retort food pouch of claim 1, wherein the biodegradable printed layer comprises:
from about 10 to about 99 weight percent polyhydroxyalkanoates;
from about 1 to 90 weight percent of at least one biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof;
from about 0.1 weight percent to about 5 weight percent of at least one nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, boron nitride, and mixtures thereof; and
optionally, from about 1 to about 25 weight percent of at least one filler selected from the group consisting of clays, calcium carbonate, talc, kaolinite, montmorillonite, bentonite, silica, chitin, titanium dioxide, nano clay, and mixtures thereof.

17. The retort food pouch of claim 1, wherein the biodegradable, printed layer comprises a core sub-layer and at least one skin sub-layer.

18. The retort food pouch of claim 16, wherein the polyhydroxyalkanoate in the biodegradable printed layer comprises poly-3-hydroxybutyrate-co-3-hydroxyhexanaote (P3HB-co-P3HHx).

19. The retort food pouch of claim 16, wherein the biodegradable printed layer comprises from about 1.0 to about 15.0 weight percent of at least one polyhydroxyalkanoate comprising from about 25 to about 50 mole percent monomer residues of a 3-hydroxyalkanoate selected from the group consisting of 3-hydroxyvalerate, 3-hydroxyhexanoate, 3-hydroxyoctanoate, 3-hydroxydecanoate, and mixtures thereof.

20. The retort food pouch of claim 16, wherein the biodegradable printed layer comprises a polyhydroxyalkanoate terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate selected from the group consisting of 3-hydroxyvalerate, 3-hydroxyoctanoate, 3-hydroxydecanoate, and mixtures thereof.

21. The retort food pouch of claim 16, wherein the biodegradable printed layer comprises polyhydroxyalkanoates having a weight average molecular weight from about 50 thousand Daltons to about 2.5 million Daltons as determined by ASTM D 5296-05.

22. The retort food pouch of claim 1, wherein the biodegradable printed layer has a thickness from about 5 to about 25 microns.

23. The retort food pouch of claim 1, wherein the biodegradable printed layer is printed using a flexographic, gravure, or digital printing method.

24. The retort food pouch of claim 1, wherein the layers are adhered together with at least one adhesive which comprises at least one polymer selected from the group consisting of polycaprolactone, isocyanates, polyurethanes, polybutylene succinate-co-adipate, polybutylene adipate-co-terephthalate, polyhydroxyalkanoates, polylactic acid, and mixtures thereof.

25. The retort food pouch of claim 1, wherein all the layers of the multi-layer structure have a melting point greater than 120° C. as determined by ASTM E794-06.

26. The retort food pouch of claim 1, wherein the retort food pouch has a shelf-life of at least 18 months, as determined by ASTM E2454.

27. The retort food pouch of claim 1, wherein the multi-layer structure has an oxygen transmission rate of less than 0.45 ml/m²/24 h, as determined according to ASTM D3985.

28. The retort food pouch of claim 1, wherein the multi-layer structure has a water vapor transmission rate of less than 0.2 g/m²/24 h, according to ASTM F1249.
